(19) United States
(12) Patent Application Publication
(10) Pub. No.: US 2016/0087806 A1
(43) Pub. Date: Mar. 24, 2016

(54) MOBILE DEVICE AUDIO/VIDEO LEGAL APPLICATION SOFTWARE

(71) Applicant: STEVEN Thomas GENTER, Valley Village, CA (US)

(72) Inventor: STEVEN Thomas GENTER, Valley Village, CA (US)

(21) Appl. No.: 14/675,593

(22) Filed: Mar. 31, 2015

Related U.S. Application Data
(60) Provisional application No. 62/053,074, filed on Sep. 19, 2014.

(51) Int. Cl. H04L 9/32; G06F 21/62; G06F 21/16

(52) U.S. Cl. CPC H04L 9/3297; G06F 21/16; G06F 21/629

(57) ABSTRACT

A tamperproof date/time stamp method that adds a real-time tamperproof date/time stamp to a digital audiovisual file includes generating at least one real-time date/time stamp and applying the date/time stamp to the digital audiovisual file. The real-time date/time stamp can be created through the location-based service in tablet computers. It can also be created through an internal clock running in the background of the application that incorporates the correct date/time from an Internet handshake with a remote server. A system for audio or video recording using a tablet computer includes an audio or video recording software module and a time-stamp software module that generates at least one real-time date/time stamp.

### CROSS-REFERENCE TO RELATED APPLICATIONS

This application claims priority to, and the benefit of the earlier filing date of: US provisional patent application entitled, “MOBILE DEVICE AUDIO/VIDEO LEGAL APPLICATION SOFTWARE”, filed on Sep. 19, 2014, Ser. No. 62/053,074, pursuant to 35 USC 119, the contents of which are incorporated herein by reference in its entirety.

### BACKGROUND

1. Field of the Technology

Embodiments are generally related real-time date/time information generation. Embodiments are also generally related to a method to apply date/time information to a video/audio file. Embodiments are additionally related to a system to record an audio/video file with integrated date/time stamp.

2. Description of the Prior Art

Taking pictures, recording audio and video is increasingly used in all life's applications. On one hand, they are frequently used for entertainment purposes. On the other hand, they are increasingly important as a way to generate an official record. Professionals such as attorneys, psychiatrists, police officers, and security staff use them as part of their routine work. Nonprofessionals have a need for audiovisual recordings in ordinary life as well. For example, when two cars collide on the road, the first thing people may do is to take pictures or record videos of the scene.

While tablet computers such as iphone or ipad nowadays are satisfactory for taking pictures or audiovisual recordings for entertainment purposes, especially professionals seldom use them for generating an official record. One critical reason is that these digital files can easily be tampered with either by people faking the content of the original file before and/or while it is being taken or by modifying the contents afterwards. The time and date of creation of the record is often the single most important content element of an official record. However, it is easily altered in tablet computers because the users may just manually set the date and time. The manually set date and time nonetheless is integrated into the digital file generated on these devices as the file creation time.

Accordingly, professionals frequently depend on other ways to generate a legally reliable record of the record's creation time and date. For example, when attorneys take legal depositions, they hire a non-interested third-party videographer. At the beginning of the video recording, the videographer orally states the date and time. The service of videography, however, is quite expensive. Normally videographer charge around two hundred dollars an hour. For a profession that relies on the videographer to keep official records, it is not surprising that their expense will be hundreds of thousands dollars a year. Furthermore, videographer generally still use camera or camcorder for such tasks. Thus, this also results in lead contamination.

Therefore, what is needed is a system that can be incorporated in tablet computers for audio or video recording with a legally reliable date and time stamp without reliance on a third party videographer. What is needed is a reliable, tamperproof method that can add a real-time date/time stamp to a digital file on tablet computer system without reliance on a third party videographer.

### BRIEF SUMMARY

It is one aspect of the disclosed embodiment to provide for audio/video recording with an integrated date/time stamp without reliance on a third party videographer.

It is another aspect of the disclosed embodiments to provide for a method and system for generating a tamperproof real-time date/time stamp for a digital file without reliance on a third party videographer.

It is yet another aspect of the disclosed embodiments to provide a method and system for generating a real-time date/stamp for a digital file on the device of tablet computers using a location-based service without reliance on a third party videographer.

It is another aspect of the present invention to provide for an audio/video recording system/method that generates a real-time date/time stamp for an audio/video file on a tablet computer without reliance on a third party videographer. The date/time stamp can be generated through at least two mechanisms. One is through the location-based service internal in the tablet computer. The second is through an internet handshake between the said tablet computer and a remote server.

It is another aspect of the present invention to provide for an audio/video recording system/method that has an integrated real-time tamperproof date/time stamp and a location coordinates without reliance on a third party videographer. The system also has a panel of functions that allow user to use. They includes optimal settings of the recording (both manual/auto focus and volume input adjustment), pause/resume recording, and video-recording two or more simultaneously.

The aforementioned aspects and other objectives and advantages can now be achieved as described herein. The real-time date/time stamp is generated when a user decides to accept the location-based service upon a reminder pushup generated by the application. When a user refuses to accept the location-based service, the real-time date/time stamp is generated through another mechanism. In this mechanism, the real-time date/time stamp is generated when a user inputs the validation key, which allows an Internet handshake between the tablet computer and the remote server. During this Internet handshake, a correct date/time record with a 24-hour clock running from that date/time is imprinted into the application. The 24-hour clock running from a particular date/time time point keeps running in background of the application without depending on the Internet network. When a user declines to use location-based service, or when a user cannot access Internet, the application incorporates the date/time from the background 24-hour dock to an audio/video/other forms of digital file when it is created.

In one embodiment of the system that designed especially for officials or professionals, user can choose to use location-based service or manually set up the date/time. In this embodiment, since a third-party always declares correct date/time at the beginning of the audio/video recording, tamperproof function is accomplished without the use of Internet shaking mechanism of real-time date/time incorporation.

In one embodiment of this system/method, users can manually zoom-in or zoom-out, optimizing the recording condition, pause and resume while recording, and simultaneously using two or more cameras and showing the recorded videos in the same screen real-time.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

FIG. 1 is a process flow chart according to one embodiment of the invention illustrating a process for an Internet handshake that can authenticate a validation key.

FIG. 2 is a process flow chart according to one embodiment of the invention illustrating a process for establishing application settings.

FIG. 3 is a process flow chart according to one embodiment of the invention illustrating a process for generating a tamperproof real-time date/time stamp.

FIG. 4 is a process flow chart according to one embodiment of the invention illustrating a process for effecting various recording operations.

### DETAILED DESCRIPTION OF THE PREFERRED EMBODIMENTS

The term, “tamperproof” as used in this specification only applies to the original digital audio and/or video file (or other form of digital file). It is defined as a way of preventing the related information being tampered with when the user fakes the date/time before or while he or she creates such a file. “Real-time date/time stamp” is defined in this specification as a way of saving the correct date and time along with the digital file. One example of the real-time date/time stamp is showing the real-time date/time on the screen when the audio/video file is recorded. Another example is when the correct date/time information is saved in the metadata of the digital file. Use in an app or mobile application here is provided as one embodiment of this invention.

Location-based services are used in mobile device technology to establish the location or time of location for the device. These services are typically internet based utilizing an internet server or redirecting mechanism to redirect the devices connection point via an internet connection or network to a network or GPS beacon which establishes the mobile devices latitudinal and longitudinal location thus allowing the mobile device to reset its date and time based on the location of the device.

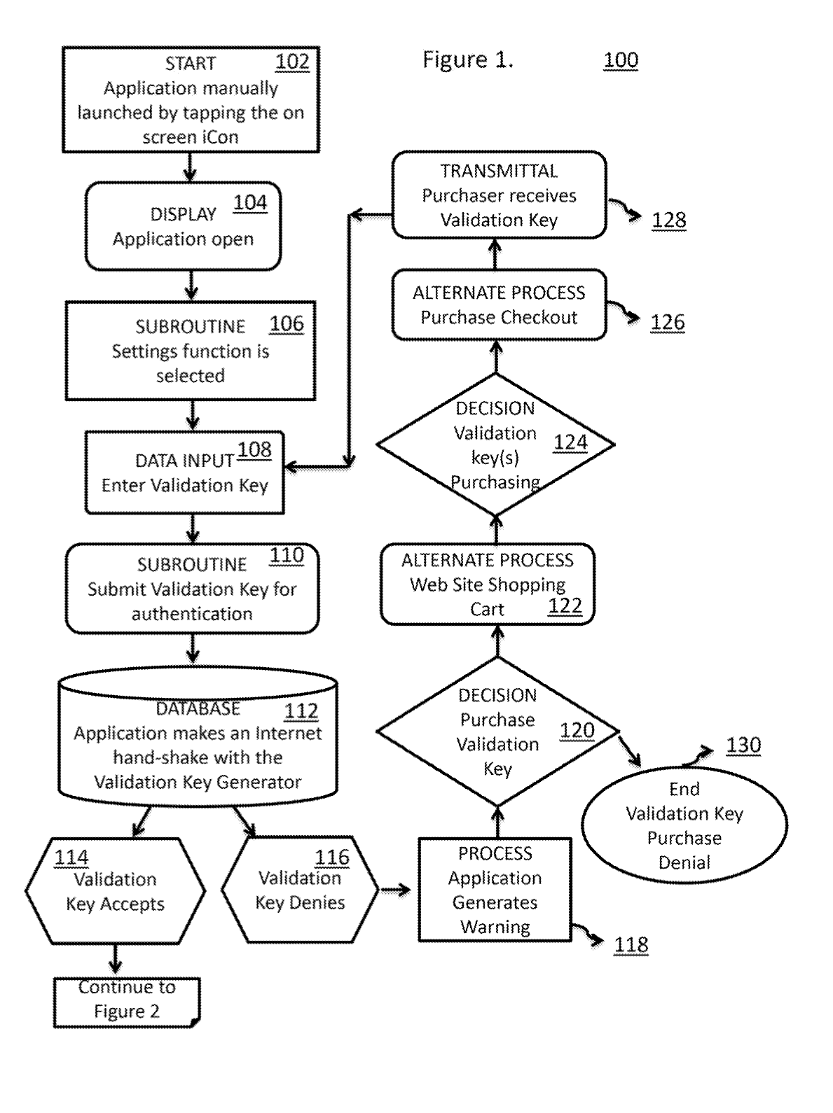

FIG. 1 illustrates a process 100 for an Internet handshake that can authenticate a validation key. The operator manually launches the application typically known as a Mobile APP by tapping the mobile devices on screen iCon at step 102. The APP or application is a custom program developed to work within many different tablet computer devices including mobile markets such as Apple iphone or Android.

The mobile application opens with a standard or temporary operating time of ten minutes at step 104 as a means of allowing the operator of the newly installed application ample testing time prior to committing to purchasing a validation key or keys. The Application may be used as many times deemed necessary until the operator is aquatinted with the application. Longer testing or operation times longer than ten minutes require a Validation Key. It is to be understood that the selection of different testing time periods is within the scope of the invention.

The mobile application at step 106 allows for a settings subroutine to control or override manual settings at any time during operation. Additionally the settings function may be used to manually override any mobile device standard modes of operation by allowing further functionalities in the application's area of intended use. Continued use of the application beyond the ten-minute testing period requires a Validation Key to be entered at step 108. This validation key is not meant to be understood in terms as if it were only a physical key for unlocking a lock or automobile. Its intended purpose is to unlock the 24-hour of software application operation time by entering an alphanumeric value. Alphanumeric validation keys are submitted for authentication by the mobile application's software through an Internet handshake at step 110 with a remote server that generates alphanumeric validation keys.

A database of an alphanumeric validation key generator shakes hands at step 112 via Wi-Fi or other Internet connection with the mobile application either granting the alphanumeric validation key as approved at step 114 or denied at step 116. By using this method of entering an alphanumeric validation key, the application operator is made aware of his or her successful use or not of the mobile application at time of alphanumeric validation key entry.

When alphanumeric validation key matches a valid active validation key via the alphanumeric validation key generator, the operator is allowed at step 114 a 24-hour period of time to use of the mobile application software. On the other hand, if the operator enters an expired or incorrect alphanumeric validation key at step 116, the operator will receive a series of warnings generated by the validation key generator communicating with the mobile application at step 118. The operator then decides whether to make an alphanumeric validation key purchase at step 120. If operator opts out of purchasing an alphanumeric validation key, he or she may use the mobile application in the demonstration mode only with the purchase denial at step 130.

If operator decides to acquire an alphanumeric validation key or keys, he or she is directed to an Internet shopping cart at steps 122-126. The operator or customer may select or enter any value of alphanumeric validation keys they require at step 122. After the operator decides to make a purchase at step 124, he or she may proceed to an alternative process check out at step 126. The alternate process check out at step 126 is either a utility or secondary mode of operation provided by credit card processing companies or online payment methods such as PayPal. The operator's alphanumeric validation key or keys are sent to the purchaser's email or sub-email account by means of email socket connectivity to their subscribing email or providers' email service at step 128. The process then returns to step 108 for entry of the newly purchased validation key.

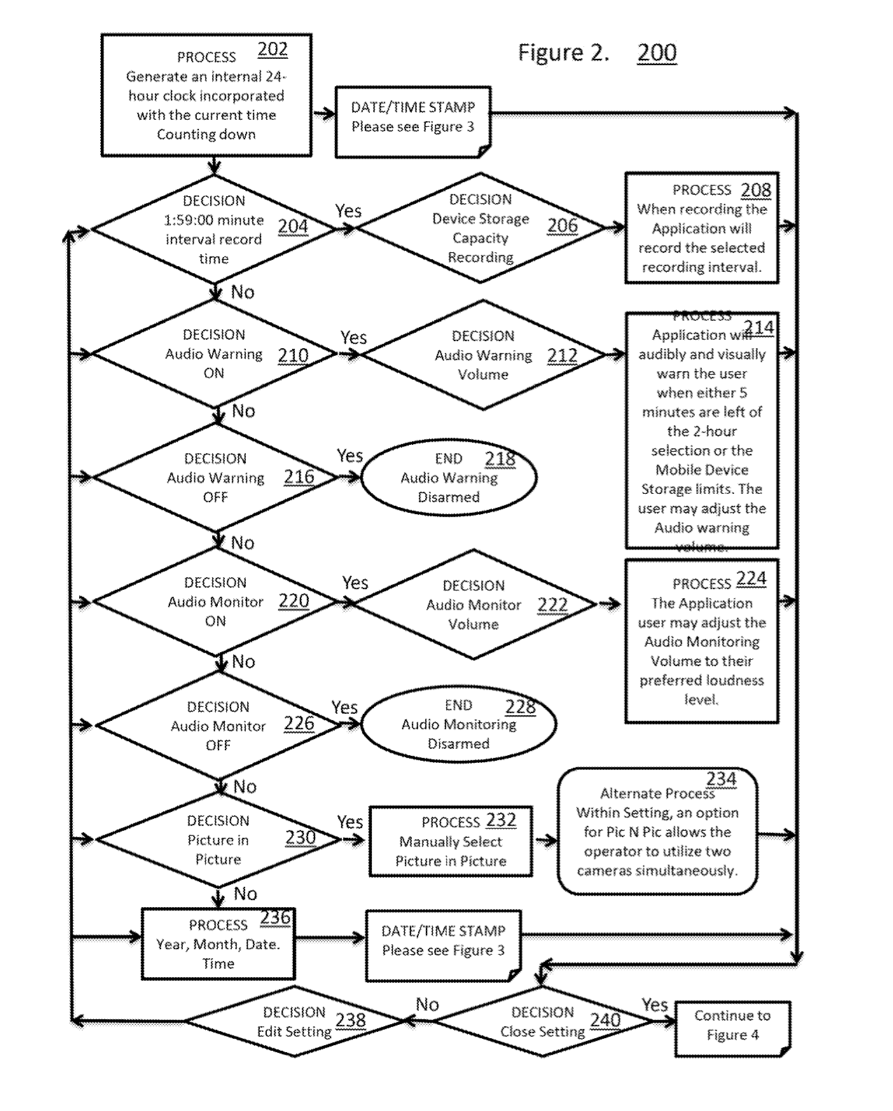

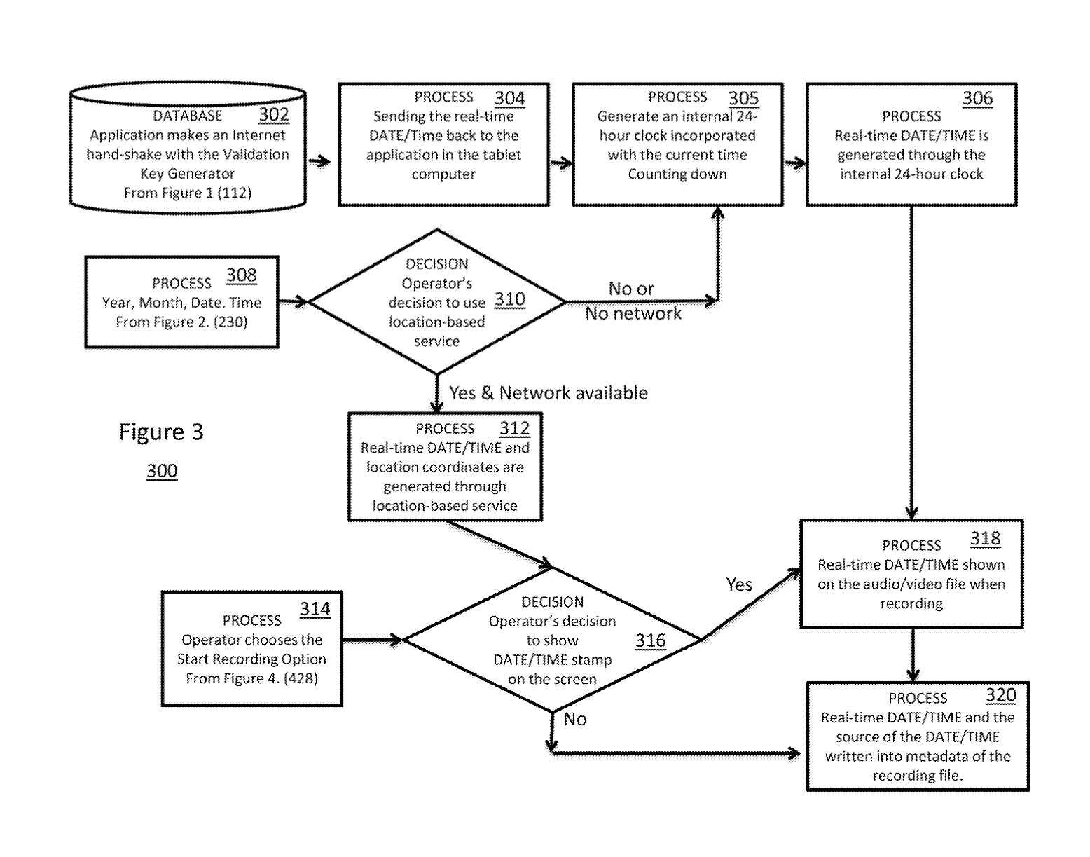

FIG. 2 is a flow diagram, which illustrates how to establish the application setting 200 after the validation key is approved in the process 100 of FIG. 1. When an operator enters an alphanumeric validation key, the system responds with a message, such as Active, Authenticated, Authentication Approved. After that, an internal 24-hour clock incorporated with the current time is counted down in background task list of the application at step 202. FIG. 3 illustrates the detail of this process 300. The system is set up in such a way so that the user validates the key through Internet handshake hours before he intends to record audios or videos. Step 204 displays for example 1:59:00 representing a 2-hour audio/video recording as an interval or use. The operator chooses this function if he or she wants audio/video to be recorded in a two-hour segment. Device capacity audio/video recording allows an operator to continue using the application up to the point when the tablet computer reaches its maximum storage limit at step 206. Depending on the current device storage limits, this may be anywhere from 4 to 20 or more hours. The operator chooses this function if he or she wants a non-interval video/audio recording. When the audio/video recording process is manually applied, the application will record in either the time interval or device capacity mode at step 208.

The operator makes a selection at step 210 if an audible warning is desired. This is like a time clock or bell keeping the operator informed audibly of the application's warnings. The operator manually adjusts the desired audio warning by sliding the volume level indicator adjustment at step 212. This allows the operator to increase the application's warning volume outside of the mobile device's internal volume level. The tablet computer device additionally allows for a volume control as a standard procedure of increasing the listening volume. The application's warning volume allows the user to customize the total application's warning volume along with the tablet computer's summed volume. The application software will audibly warn the user via the tablet computer device internal speaker or external headphones at the preferred or summed volume level within applicable time of the remaining 2-hour recording selection or when the device's storage capacity is nearly reached at step 214. The application software visually informs the user when he or she is within 5 minutes of the 2-hour interval record time or device capacity limits.

The operator may opt out of the audio warning by selecting audio warning off at step 216. The user will not receive any audio time or device storage limits warnings since it is set in a disarmed state at step 218. The user will continue to receive the visual warnings, as the visual warnings are application-programmed as non-selectable options.

The operator selects audio monitoring of the recording as their preferred choice in step 220. This allows the operator to audibly listen to the actual recording being recorded in the device's internal storage. The operator may adjust the monitoring volume by increasing or decreasing the monitoring volume level at step 222. The application software will audibly produce the preferred audio level via the mobile applications and mobile device's preferred or summed listing level at step 224.

The operator can manually select or turn off audio monitoring steps 226-228. This would be a preferred and recommended setting if the user does not insert headphones into the mobile device's headphone connection plug or connector. Turning off audio monitoring will allow the device to record audio without being interrupted by audio feedback. If the operator turns off audio monitoring at step 228, it does not affect the audio warning or warning volume set earlier in FIG. 2.

The operator has a selection to use Picture In Picture 226. This allows the operator to select an operation of utilizing both tablet cameras simultaneously. The operator may select “Pic N Pic” to further select either the forward or rear-facing camera as their primary “Larger” image 228. The Pic in Pic image of either the forward or rear-facing camera is then displayed within the larger image. Both images are video and audio recorded to the devices internal storage, and can be played back as they were recorded.

The application generates a tamperproof real-time date/time stamp through a process elaborated in FIG. 3 at step 236. When the operator chooses to use Pic N Pic and chooses to show the real-time date/time stamp, the time stamp is showed on the larger camera picture. After step 236, the operator may now close the settings at step 240 or edit settings at step 238 prior to closing.

FIG. 3 illustrates one embodiment of how to generate a tamperproof real-time date/time stamp in the process 300. Two mechanisms are elaborated in process 300. The first is through the Internet handshake between the tablet computer and the remote server that generates the validation key at steps 302-306. The remote server keeps a correct date and time depending on a location-based service or an equivalent method. When an operator submits the validation key to the server, after the server acknowledges that the key is correct, the server submits the real-time date and time information back to the tablet computer step 304. At the same time the server will record the date/time along with the validation key in its database. After the application receives this date/time information, it generates an internal 24-hour clock counting from this date/time in its background task at step 305. While the operator decides to record an audio/video file and she or he declines to use the location-based service or cannot access the Internet at that time, the application grabs the date/time information from that running internal clock at step 306. For example, if the Internet handshake happens at 1:00:00 am on Jan. 1, 2014. The internal clock runs from 1:00:00 on Jan. 1, 2014 to 1:00:00 Jan. 2, 2014. The operator decides to record on 12:00:00 on Jan. 1, 2014. However, there is no network at that time he can use. Then the application grabs the date/time “12:00:00 1/1/14” from the background clock and electronically stamps it on the recorded video. The operator may choose at step 318 to show the date/time stamp on the screen while the audio/video file is being recorded. If the operator chooses to do so, the date/time shown on the screen is updated every second to track the internal clock in the background task.

On the other hand, a location-based service is ordinarily internally integrated in tablet computers nowadays. This service allows a real-time update of both the date/time information and the location coordinates of the tablet computer. If the operator, while he or she decides at step 308 to start recording, has access to the Internet and chooses to use the location-based service at step 310, a real-time date/time stamp and the location coordinates are generated through this service at step 312. Similarly, operator may choose at step 316 to have this date/time stamp shown on the screen at step 318 while he or she is recording an audio/video file.

No matter how the real-time date/time stamp is generated, the application writes the real-time date/time information along with the source of this information in the metadata of the recorded file at step 320. If an operator chooses to use the location-based service and successfully uses this service, the location-coordinates are also written into the metadata of this recorded file.

In one embodiment of this invention that is specifically designed for professionals and officials, the user is allowed to choose either location-based service or a manual set up the date/time/location. In such occasions, tamperproof date/time is also established because a non-interested party usually announces the date/time at the beginning of the recording as the conventional practice.

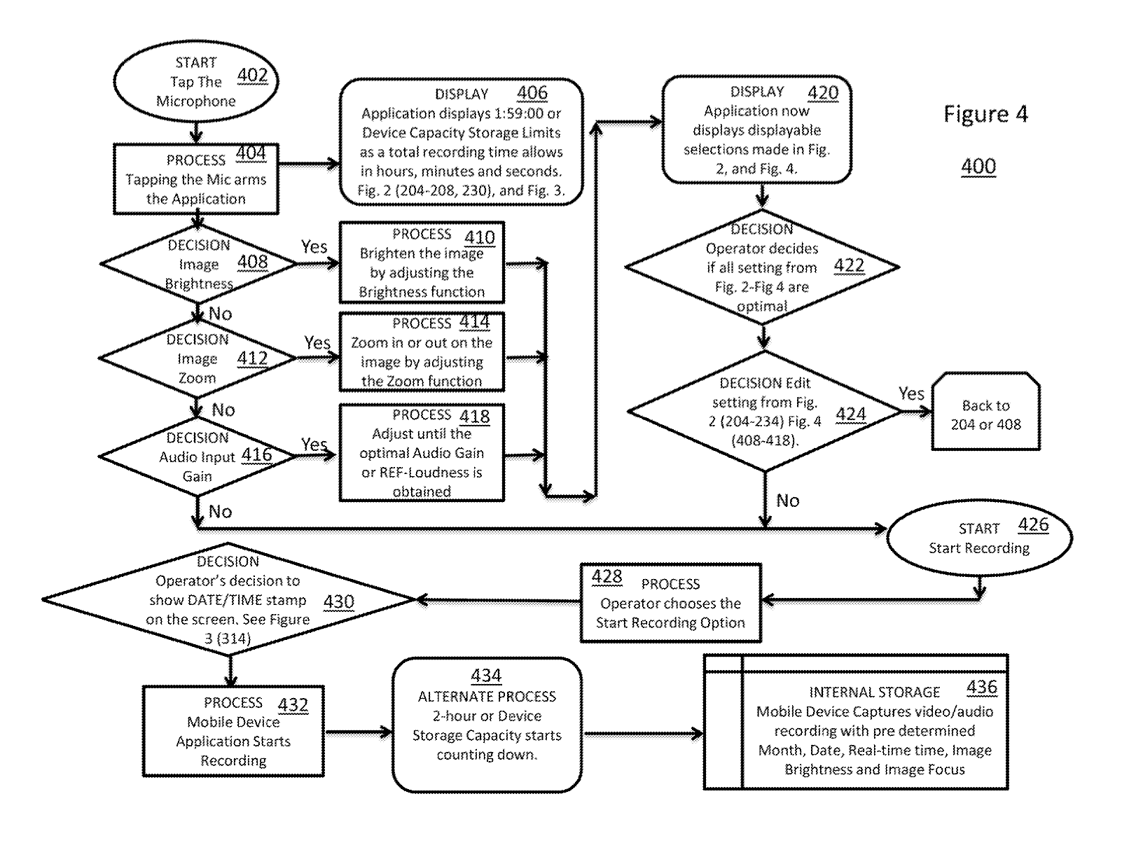

FIG. 4 illustrates how to effect various operations using the process 400. The operator taps the microphone icon located on the recording operation touchscreen interface at step 402. Tapping the Microphone icon arms the application at step 404. Additionally arming the application allows the application to receive audio input along the video image captured by the mobile device's rear-facing camera. The display shows the image, an audiometer loudness level, the selected record time in the 2-hour interval or the device's storage capacity in hours, minutes and seconds at step 406.

The operator may decide at any time during activation of the recording to adjust the brightness of the image and image background at step 408. Brightening the image or image background is a process known as adjusting image brightness or contrast, as this allows the operator to custom tailor the image presentation prior to or during recording at step 410. Typically during the daylight, intensity may be increased by turning on additional lights in a room or by rising or setting of the sun in particular situations.

Image zoom is a manual process an operator may use to zoom in or out on a particular object or person within the application software at step 412. The application's programming is set at step 414 to only allow for manual zoom, thus overriding the device's autofocus and distortion or blurring caused by the device's programming preferences. This is because mobile devices are typically programmed to autofocus which creates a distortion or blurring of the image for a fraction of a second or longer.

Auto input or gain is a function of increasing or decreasing the microphone or external microphone preamps input level in db-Decibel Level or by following AES-EBU standards of audio engineering at step 416, as it is commonly practiced in the professional audio world. The operator may adjust the device's internal microphone gain within the application by manually adjusting the application gain-loudness adjustment at step 418. The operator may also adjust the loudness by connecting a dynamic or condenser or powered microphone or preamp mixer to the device and manually adjusting the gain-loudness within the application.

The operational application also displays at step 420 all displayable settings made in processes illustrated in FIGS. 2-4. The operator decides at step 422 if all settings from FIGS. 2-4 are to his or her preference. If the operator's decision is to edit any settings, he or she may do so at this time be selecting the settings icon at step 424. The operator may make any changes to any or all of the settings in FIGS. 2-4.

Then the operator chooses to start recording at steps 426-428. The operator may choose to show the date/time stamp generated in FIG. 3 on the screen while the audio or video is being recorded at step 430. No matter whether he or she chooses to show or not show the date/time stamp on the screen, the real-time date/time information is saved in the metadata of this digital audio and/or video file. This application starts the recording of an audio/video file with at least one tamperproof real-time date/time stamp at step 432. The 2-hours interval record time or the device's storage capacity starts counting down in clock hours at step 434. The device's internal storage captures the audio/video recording with the addition of the real-time date/time, image brightness and image focus at step 436.

Another feature of this invention is pause-resume recording. The operator has the capability of pausing the recording at any time during the recording process. The operator pauses the recording by selecting the pause button. Selecting the pause button additionally changes the icon to display record option icon. The pause function keeps the previous recorded video/audio in a holding pattern within the device's internal storage by means of application's programming logic code. When manually activating the pause selection, this stops the countdown limit on the recording time clock 2-hour or device capacity. However the background 24-hour clock keeps running. When operator decides to resume the recording, he or she selects the continue recording icon. The 2-hour clock or device capacity storage limit continues to countdown.

Another feature of this invention is to autosave when the time is limited. The application is programmed to autosave an audio or video file when time or storage limit is reached. In detail, this autosaving feature is designed to save a 2-hour or the audio/video file up to the expiration of the selected file recording time or device storage limits. It generates multiple warnings that allow the user to confidently use the application knowing that how much time estimated remains available for recording. When the device has no remaining internal storage capacity, operator may choose to stop recording, or arrange the internal storage to render more storage capacity, or connect the device with an external computer to render more storage capacity. After more storage is available, operator may choose to resume the recording. The recorded file is autosaved every 15 seconds. A video file is saved in a conventional a format of the audiovisual record including but not limited to mpeg1, mpeg2, mpeg3, mpeg4, .mov, .m4v, H.263, H.264, 0.3gp, .webm, .mkv, M-JPEG, .AVI, .mdb.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A method for inserting a real-time digital tamperproof date/time stamp into a digital audio and/or video file to be stored or stored in a memory medium of the electronic file comprising:
sending a request to a predetermined authentication source for a digital real-time date/time stamp;
generating at least one digital real-time date/time stamp by the predetermined authentication source; and
incorporating the digital real-time date/time stamp into the electronic file.

2. The method of claim 1, further comprising generating the digital audio and/or video file as a user recorded audio or video file generated by a mobile computer application.

3. The method of claim 1, where generating the at least one digital real-time date/time stamp by the predetermined authentication source comprises generating the date/time stamp as a combination of a date and time when the digital audio and/or video file is first begun to be recorded.

4. The method of claim 2, where generating at least one digital real-time date/time stamp by the predetermined authentication source comprises selectively choosing to generate the digital real-time date/time stamp using an internal location-based service within the mobile computer application.

5. The method of claim 2, where generating at least one digital real-time date/time stamp by the predetermined authentication source comprises generating the digital real-time date/time stamp through an Internet communicated remote server.

6. The method of claim 1, further comprising recording both the digital real-time date/time stamp and identification of the authentication source and making the digital real-time date/time stamp and identification of the authentication source accessible to a user.

7. The method of claim 1, further comprising selectively displaying the digital real-time date/time stamp on a local screen and simultaneously and continuously incorporating an automatically updated digital date/time stamp into the digital audio and/or video file while the audio and/or video file is being recorded.

8. A system for creating an audio and/or video recording using a tablet computer in combination with a predetermined authentication source, comprising:
at least one module to request and generate a digital time/date stamp from the predetermined authentication source;
an audio and/or video recording module for generating an audio and/or video record; and
a time-stamp module to insert the digital real-time time stamp into the audio and/or video record.

9. The system of claim 8, wherein the module to request and generate the real-time digital time/date stamp from a predetermined authentication source comprises a module for accessing a user selected location-based service as the predetermined authentication source and generating at least one real-time date/time stamp from the said service.

10. The system of claim 8, wherein the module to request and generate the real-time digital date/time from a predetermined authentication source comprises requesting and generating a real-time digital time/date stamp through an Internet communicated remote server.

11. The system of claim 8, wherein at least one camera and one microphone is coupled with the tablet computer; and the said camera and said microphone generates the audio and/or video record in a format including but not limited to mpeg1, mpeg2, mpeg3, mpeg4, .mov, .m4v, H.263, H.264, 0.3gp, .webm, .mkv, M-JPEG, .AVI, .mdb.

12. The system of claim 8, further comprising a module to record both the digital real-time date/time stamp and identification of the authentication source and to make the digital real-time date/time stamp and identification of the authentication source accessible to a user.

13. The system of claim 8, further comprising a local display of the digital real-time date/time stamp and where the a time-stamp module to insert the digital real-time time stamp into the audio and/or video record simultaneously and continuously incorporates an automatically updated digital date/time stamp into the digital audio and/or video file while the audio and/or video file is being recorded.

14. The system of claim 8, further comprising a global positioning circuit communicated with the computer for generating a latitudinal and longitudinal location embedded into metadata included in the audio and/or video record.

15. The system of claim 8, further comprising a camera, a display and a speaker and a user selected control for the camera, display and speaker, all of which are communicated to the tablet computer, and to adjust brightness of the display, volume of the speaker, and manual focus of the camera.

16. The system of claim 8, further comprising a user selected control communicated with the tablet computer wherein a user can pause and resume recording of the audio and/or video record while keeping an automatically updated continuous digital real-time stamp.

17. The system of claim 8, further comprising a plurality of cameras to simultaneously to record a corresponding plurality of videos and a display communicated with the computer to allow simultaneous display of the plurality of videos.

18. A method for inserting a real-time tamper-proof digital date/time stamp into a digital audiovisual file comprising:
requesting a real-time digital date/time stamp from a predetermined authentication source;
generating at least one digital real-time date/time stamp by the predetermined authentication source;
incorporating the digital date/time stamp into the digital audiovisual file;
generating the digital audiovisual file as a user recorded file generated by a mobile computer application;
recording both the digital real-time date/time stamp and identification of the authentication source and making the digital real-time date/time stamp and identification of the authentication source accessible to a user; and
selectively displaying the digital real-time date/time stamp on a local screen and simultaneously and continuously incorporating an automatically updated digital date/time stamp into the digital audiovisual file while the audiovisual file is being recorded.

19. The method of claim 18, where generating at least one digital real-time date/time stamp by the predetermined authentication source comprises selectively choosing to generate the digital real-time date/time stamp using an internal location-based service within the mobile computer application, and generating the digital real-time date/time stamp through a validation request to an Internet communicated remote server.
